(19) United States
(12) Patent Application Publication
(10) Pub. No.: US 2019/0133212 A1
(43) Pub. Date: May 9, 2019

(54) Child Safety Seat Compatible Apparel System

(71) Applicants: Jamie Wallace, Gering, NE (US); Rick Wallace, Gering, NE (US)

(72) Inventors: Jamie Wallace, Gering, NE (US); Rick Wallace, Gering, NE (US)

(21) Appl. No.: 16/240,752

(22) Filed: Jan. 6, 2019

Related U.S. Application Data
(63) Continuation-in-part of application No. 15/431,919, filed on Feb. 14, 2017, now abandoned.
(60) Provisional application No. 62/297,319, filed on Feb. 19, 2016.

(51) Int. Cl. A41D 11/00; A41D 1/04; B60R 22/10

(52) U.S. Cl. CPC A41D 11/00; A41D 27/00; B60R 22/105; A41D 1/04

(57) ABSTRACT

An apparel system including a base layer component and a vest component that safely may be worn by a child in a child safety seat with a five-point harness (including convertible, combination, and forward facing with a harness). This may provide warmth for the child while transitioning from indoors to the vehicle and while traveling in the car. This apparel system also may provide protection from the elements should the child be involved in a vehicle accident. The apparel system may include a vest component, such as with a hood, that may be worn over the base layer, such as a jacket, to provide added warmth for outdoor activities. In embodiments, the vest component may not be intended to be worn, and in embodiments should not be worn, while the child is in the child safety seat. This system may be safe, versatile, and convenient.

### RELATED APPLICATIONS

This application is a Continuation-in-Part application of patent application Ser. No. 15/431,919 which was a Non-Provisional application of U.S. Provisional Application Ser. No. 62/297,319 filed on Feb. 16, 2016. All of these related applications are incorporated by reference herein in their entirety.

### FIELD OF THE INVENTION

This disclosure describes a jacket/vest system that can be safely worn by a child in a car seat with a five-point harness. The jacket can be worn during travel and the outer abdominal segment vest can be added for additional warmth during outdoor winter activities.

### BACKGROUND OF THE INVENTION

The safety of a child is the biggest responsibility given to a parent. The safety of a child while riding in a vehicle is so important to society that there are federal and state laws that regulate it. Unfortunately, confusion and inconvenience jeopardize the safety of children while riding in car seats. The present invention Quimby Coat helps eliminate that problem. The Quimby Coat even goes one step further and helps protect the child after a crash has happened.

Parents are advised to keep their children in a five-point harness from birth to approximately 65 pounds (depending on the type of car seat). This can include a wide range of ages. As children grow from an infant to a toddler, they move from an infant only car seat (with a carrier and a base) to a convertible seat. This means that the parents must remove the child from the seat instead of keeping the child in the carrier. This is when confusion and inconvenience put the child's life in jeopardy.

Instead of babies being covered in blankets or seat covers, these children are walking and wearing coats to keep them warm. Now the child must move from the warmth of the indoors to the harsh elements outside before being put in their car seat. Well intended parents bundle their kids in the winter coats and “tightly secure” them in their car seats. If the child continues to wear their coat and then the straps cannot be secured tight enough to be safe. If the parent removes the child's heavy coat (which is recommended) then the child is cold during this transition. Once the child is secured in their car seat parents are advised to cover them back up with their coat or a blanket.

In the event of a car accident, most likely, the coat or blanket will fall off. There is a possibility that windows will be broken, or significant damage will allow the passengers to be exposed to the elements. Adult occupants in the car can be injured or trapped to a point that they can't help the child. If the child is secured in their car seat and their cover has fallen off then they are exposed to the frigid temperatures, wind, and snow. This could lead to frost bite, hypothermia and death. Response times of rescue units could be considerable. This response time increases in less populated areas, on highways and on interstates. The exposure time increases if extrication is needed. This type of exposure could jeopardize the life of the child regardless of other injuries sustained. The Quimby Coat could be that additional layer of protection that the child needs.

The inconvenience of constantly removing the child's coat before getting into the vehicle and putting it back on when getting out of the vehicle might tempt parents to just let the child wear the coat in the car seat. The fact that kids have to remove their warm coats outside before getting into a (possibly cold) car doesn't appeal to parents either. The fact that their child might be exposed to the elements in the event of a car accident might also tempt parents to leave the coat on the child. Having and promoting the Quimby Coat will also educate and inform parents that heavy winter coats in car seats are dangerous.

The inventors' experiences as a fire fighter, ENT, and captain at a career fire department for 19 years and a certified child safety seat technician for eight years have shown me that this danger exists. Parents want a convenient way to keep their children safe. Parents will find that the Quimby Coat is safe, versatile, and convenient. It also provides enough warmth for their child to play outside. The versatility in transitioning the coat from the inner base layer which is compatible with a five-point harness to one that is warm enough for winter outdoor play is very simple. An outer abdominal segment vest is extremely easy for a child to put on, it provides extra warmth because of the layering system over the body and it comes with a hood.

### SUMMARY OF THE INVENTION

Currently, the recommended solution is to have a child remove their coat outside, get into the vehicle, secure them in the harness, and then cover them back up with their coat. This is uncomfortable for the child, inconvenient for the parent, and unsafe in the event of a crash. If the child is involved in a crash significant damage to the vehicle could leave the child exposed to harsh weather conditions as the loose coat could be dislodged and the child will be secured in their car seat with no coat for cold condition protection. If they were only covered with a coat or blanket and that covering has fallen off of them, then they can't get to it. It could take several minutes for firefighters to get on scene, and even longer if extrication is needed. These times could be significantly longer in less populated areas or on the interstate and highways.

The present invention relates to specifically designed child's coat that has the features of providing adequate warmth while at the same time minimizes interference with child car seat harnesses. The investors have named the present invention as the Quimby Coat™ which will be referenced herein. The Quimby Coat is a jacket system that provides the warmth of a winter coat yet is thin enough to be safely worn in a car seat that has a five-point harness. The Quimby Coat jacket system is a multi-layered structure which has an inner base layer composed of a thin, non-bulky abdominal section that is composed of a relatively non-insulated material section with a pair of bulky and insulated sleeves. The abdominal segment of the inner base layer of the coat is made from a material that provides warmth (fleece, fleece/nylon, Polar Tech Power Shield®, etc.), but is thin enough, with a minimal amount of insulating material, so that the straps of the harness fit snugly against the child's body. This feature limits the amount of space between the harness and the body.

This disclosure includes a description of an apparel system, such as an inner base layer (which may be a jacket, coat, or the like), may be safely worn by a child such as in a child safety seat with a five-point harness or the like. The inner base layer with bulky and insulted sleeves may be worn during travel in a car with a five-point child seat and with the interweaving of the outer abdominal segment vest, when the child is not in the car seat, added for additional warmth, creates a multi-layered jacket or coat to be worn during outdoor winter activities.

The abdominal section of the inner base layer also has a unique hem line cut at the center portion of the lower front portion of the inner base layer. The unique hem line cut is raised in the center front section of the base layer preventing interference with the buckle part of the harness which ensures a snug fit and complete locking.

The sleeves of the inner base layer are much like those on a winter coat. They are thicker and with heavier insulation than the inner base layer which provides maximum warmth of a winter coat but does not interfere with the harness in the car seat. This also provides added protection from the harsh weather in the event of a car crash. This makes the Quimby coat very versatile. The inner base layer of the jacket does not come with a hood to prevent any extra bulk between the child and the car seat when the hood is not on the child's head.

The system comes with a removable and interweaving outer abdominal segment vest (optionally including a hood) which can be worn when the child is NOT in the car seat. The pair of sleeves of the inner base layer exit the sides of the outer abdominal segment vest. The outer abdominal segment vest is thicker and with heavier insulation. When the inner base layer is interweaved with the outer abdominal segment vest, the resulting multi-layered coat or jacket is warm enough to be worn outdoors. This layering of the Quimby coat or jacket creates a method in which the body section that is warmer than just a single winter coat layer.

This Quimby™ coat or jacket is extremely versatile and convenient. It provides the warmth of a winter coat, but it is safe enough to be worn with a five-point harness. This system uses layering to make it even warmer when worn all together.

The convenience of this system will also prevent parents from choosing an unsafe option. It is not easy for parents to have their kids take off their coat outside in blowing snow, get in a potentially cold vehicle, and then cover them with their coat. Then once they reach their destination the child must do the same thing when exiting the vehicle. This is especially difficult with toddlers and multiple children. At times, parents might settle for the unsafe option of allowing their children to ride while wearing their coats. One option a parent might choose would be a 3-in-1 coat. This is not a good option. They do not offer the warmer sleeves, or the buckle cut out section at the bottom of the inner base layer. Putting the outer coat of a 3-in-1 over the jacket layer on a toddler is also more difficult than slipping their arms through the outer abdominal segment vest openings on the Quimby™ coat. They also don't need to attach the two sleeves inside the coat.

The jacket and vest parts of this system do not attach. This was designed with safety in mind. If both parts zipped together then it might be more convenient for parents to leave the parts connected when the child is getting into the car seat. By not designing the two parts to attach then it is always easy to remove the outer abdominal segment vest part before the child gets into the car.

### BRIEF DESCRIPTION OF THE DRAWINGS

FIG. 1 is a front perspective drawing showing the front of the inner base layer whereby this section of the coat is to be worn with the five-point harness child's car seat.

FIG. 2 is a perspective drawing showing the back of the inner base layer whereby this section of the coat is to be worn with the five-point harness child's car seat.

FIG. 3 is a perspective view of the front of the outer abdominal vest.

FIG. 4 is a perspective view of the back of the outer abdominal vest layer.

FIG. 5 is a perspective view of the front of the multi-layered jacked with a hood to be worn when the child is not secured by the restraining straps of a multipoint child's car seat.

FIG. 6 is a perspective back view of the multi-layered jacked with a hood to be worn when the child is not secured by the restraining straps of a multipoint child's car seat.

### DESCRIPTION OF THE PREFERRED EMBODIMENTS

The following sections will provide definitions of some of the terms or phrases used in this application.

The term or phrase “bulky insulation” shall mean all membrane and breathing tissues and materials that are resistant to compressing and mechanical deformation, have a porous structure that retains moist warm air from inside and prevents moisture from penetrating from the outside, and have excellent wind and moisture protection properties. Examples of superior insulations materials are Thinsulate®, Therimolite®, Primaloft® and Quallofil® that are fabricated with natural or artificial insulation materials which provide reliable thermal protection in combination with good ventilation. As an example of an artificial insulation material, Thinsulate® is composed of a plurality of particularly fine synthetic fibers with a thickness of 2 to 10 microns. Each fiber is naturally surrounded by a layer of air, which ensures preservation of heat. Since the fibers are thin, the fabric has a small weight and thickness, and does not absorb moisture or become damp. The technology of hollow fibers had further developed improved thermal insulation properties of insulating material without increasing its weight and without the use of chemical additives.

The term or phrase “thin insulated material” or “non-bulky, non-insulated” shall mean those materials that generally are thin with one or more layers and have good wind and water protection but has less heat retention qualities with compared to the bulky insulated materials. Example materials include fleece or fleece/nylon materials that provide a soft warm fabric with a texture like sheep's wool, generally used as a lining material. A commercially marketed thin insulated material is the Polartec® Power Shield® that is highly resistant to wind and water exposure, is breathable with some heat retention.

The present inventive technology includes a variety of aspects, which may be combined in different ways. The following descriptions are provided to list elements and describe some of the embodiments of the present inventive technology. These elements are listed with initial embodiments, however it should be understood that they may be combined in any manner and in any number to create additional embodiments. The variously described examples and preferred embodiments should not be construed to limit the present inventive technology to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

Currently, a typically recommended solution may be to have the child remove their coat outside, get into a vehicle, be secured into a harness, and be covered back up with their coat. This may be uncomfortable for the child, inconvenient for the parent, and unsafe in the event of a crash. If the child is involved in a crash, significant damage to the vehicle may leave the child exposed to harsh weather conditions while being secured in their child safety seat. If the child were only covered with a coat or blanket, and that covering were to have fallen off, then the child may not be able to get to it. It may take several minutes for emergency responders to get on scene, and perhaps even longer if extrication is needed. These times may be significantly longer in less populated areas or on the interstate and highways.

The convenience of the apparel system also may prevent parents from choosing an unsafe option. It may not be easy for parents to have their children take off their coat outside in blowing snow, get in a potentially cold vehicle, and then cover them with their coat. Then once they reach their destination, the child may have to do the same thing when exiting the vehicle. This may be especially difficult with toddlers and multiple children. At times, parents might settle for the unsafe option of allowing their children to ride while wearing their coats. One option a parent might choose could be a 3-in-1 coat. This may not be a good option. Such coats may not offer the warmer sleeve, or the novel cut as described herein. Putting the outer coat of a 3-in-1 over the jacket layer on a toddler also may be more difficult than slipping their arms through the outer abdominal segment vest openings on the apparel system described herein. It also may not be required to attach the two sleeves inside the coat.

In some embodiments, the inner base layer (perhaps in the form a jacket, coat, or the like) and the outer abdominal segment vest components of the apparel system may not attach. This may provide a safety benefit. If both parts attached together (such as by zipping or the like), then it might be more convenient for parents to leave the parts connected when the child is getting into a child safety seat. By not permitting the two parts to attach, it may be always easy to remove the outer abdominal segment vest component before the child gets into the car.

The following clauses may be relevant in claiming or otherwise describing the inventive technology:

1) The garment may be safe for children to wear while secured in a child safety seat with a five-point harness.

2) The garment also may provide the warmth of a winter coat and may be worn during outdoor winter activities.

3) The garment may have an inner base layer having a body section made of thinner material that may be compatible with a five-point harness.

4) The absence of a hood on the inner base layer may eliminate bulk between the child and the back of the child safety seat.

5) A novel cut on the lower half of the body section of the inner base layer may prevent interference with the buckle of a harness.

6) Heavy winter coat-type sleeves may provide extra warmth without interfering with the tightness of a harness.

The outer abdominal segment vest component may provide warmth and may allow the apparel system to function as a winter coat that may be worn in cold weather conditions.

8) The warmth of the basic layer may make a child warmer than the covering method (for example, when a child may be secured in a child safety seat in a shirt or light jacket and their winter coat or a blanket is used to cover them) in the event of a crash. It may protect the child from the elements.

9) The apparel system may make it more convenient for parents so that it may be easier to make a correct and safe choice for securing their children into a child safety seat.

As can be easily understood from the foregoing, the basic concepts of the present inventive technology may be embodied in a variety of ways. It involves both appareling techniques as well as devices to accomplish the appropriate apparel. In this application, the appareling techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

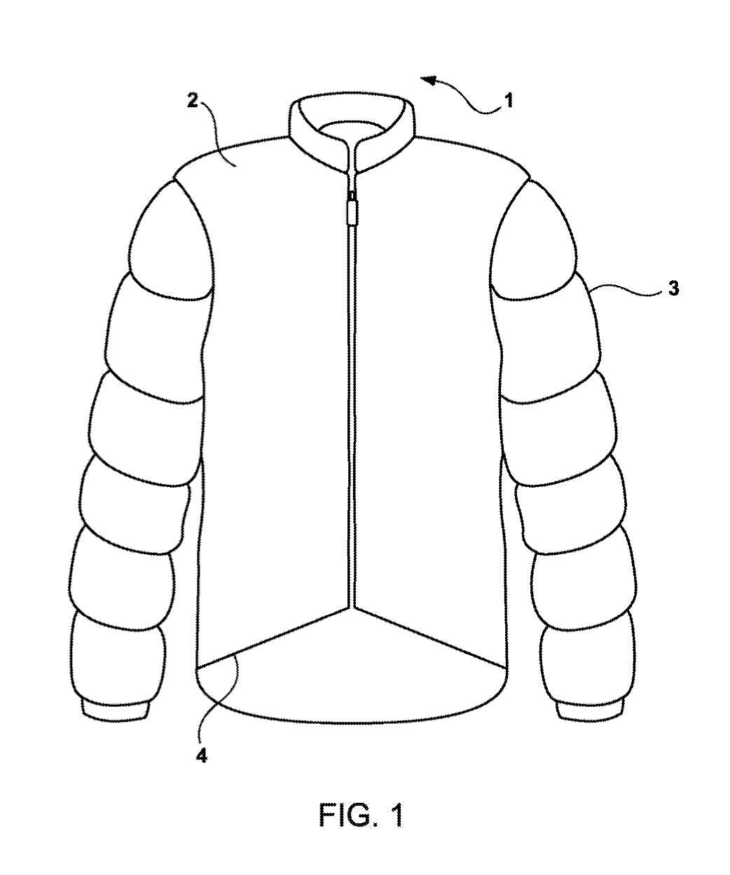

Now referring to FIG. 1 which shows a perspective view of the front of the inner base layer 1 whereby this section of the coat is to be worn with the five-point harness associated with a child's car seat. The inner base layer 1 comprises an inner abdominal section 2 that is fabricated from a thin insulated material. The inner abdominal section 2 is connected to a pair of sleeves sections 3 that are comprised from a bulky insulated material. The insulated sleeves provide the warmth of a winter coat, but do not interfere with the harness.

Also shown is this FIG. 1, the inner base layer also may have a novel cut with a raised hem line 4, located at the front center of the lower half of a jacket, that may prevent interference with a fastener, such as the buckle part of a harness or the like. As shown, the cut or raised hem line section 4 is triangular is shape in the drawing but can be other configurations. The main purpose of the cut or raised hem line 4 is to minimize interference with the front buckle of the five-point harness strap system. The cut or raised hem line 4 on the bottom half of the front of the coat prevents bulky material from interfering with the fastener or buckle. The length of this cut is determined by the measurement of the back of the jacket. A measurement is taken off the back of the jacket from the top of the collar to the bottom of the jacket. The length of the cut on the front is approximately 17% of the back of the jacket.

Also shown in FIG. 1 is that the inner abdominal section 2 has a zipper adjoining the left and right panels. It is anticipated that the left and right panels can be joint by other means such as using a plurality of buttons with button holes, Velcro® or another hook and loop technology. Notice that the inner base layer 1 has an absence of a hood which prevents bulk between the child and the back of the car seat. The material that makes up the inner base layer 1 of the jacket is thin enough to be compatible with the five-point harness but is durable and warm enough to protect the child against the elements. This part of the jacket also acts as the first layer in a double layer system when worn with the outer abdominal segment vest to provide extra warmth. This thin insulated material can be fleece, fleece/nylon, PolarTec® Power Shield®, or many similar types of materials.

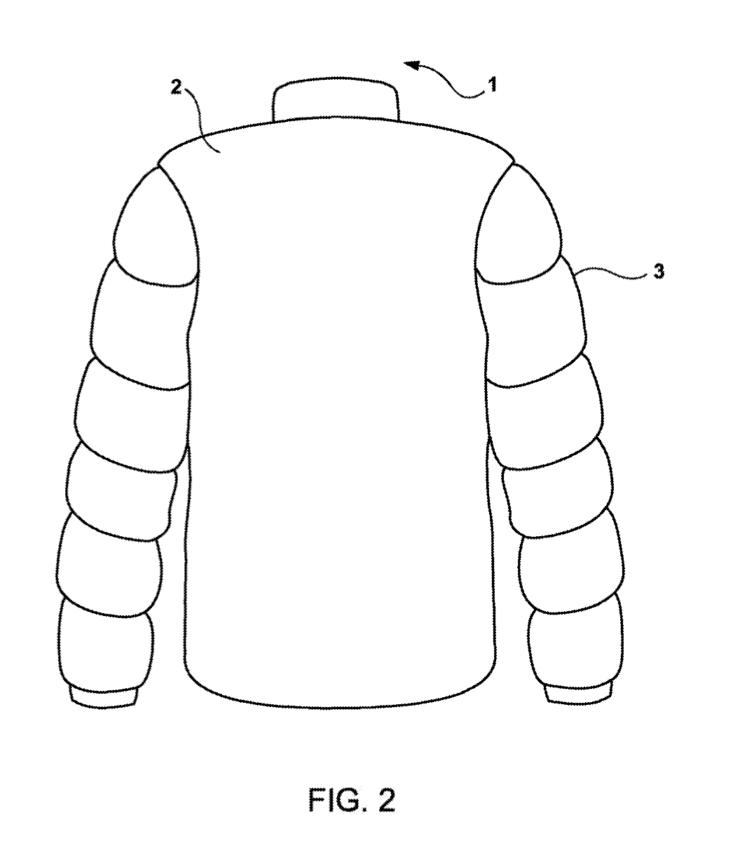

Now referring to FIG. 2 which show a rear perspective drawing showing the back of the inner base layer whereby this section of the coat is to be worn with the five-point harness child's car seat. The back section is comprised from the thin insulated material (fleece, fleece/nylon, PolarTec® Power Shield®, or many similar types of materials) and may be continuous from the front inner base layer. It is anticipated by the Applicants that the thin insulated material on the front side may be different from the thin insulated material on the back side of the inner base layer.

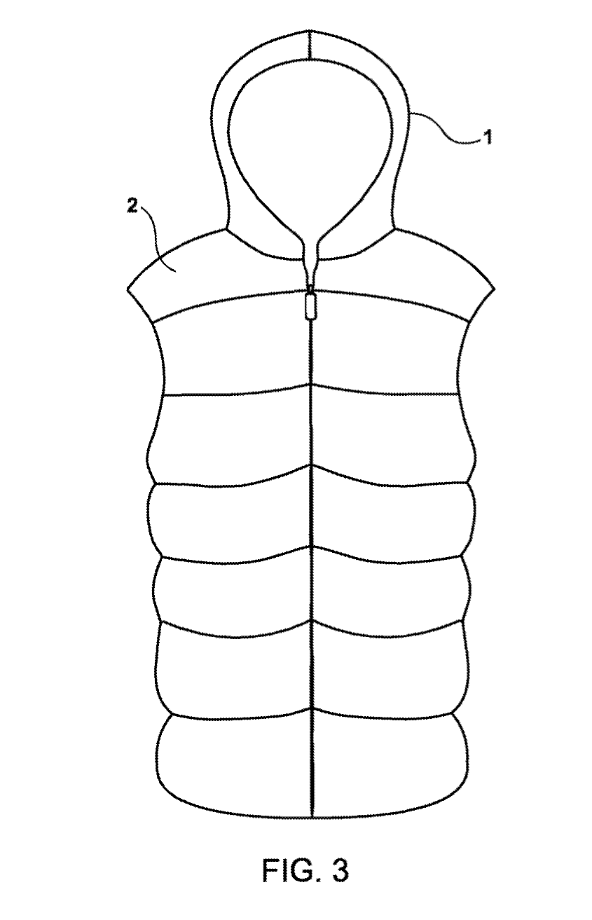

FIG. 3 shows a front perspective view of the outer abdominal vest. This part of the present invention jacket or coat apparel system is not be intended to be worn while the child is in a five-point harness or similar safety device. The outer abdominal vest 2 comprises bulky insulated materials. Also shown in FIG. 3 is that the outer abdominal vest has a zipper adjoining the left and right panels. It is anticipated that the left and right panels can be joint by other means such as using a plurality of buttons with button holes, Velcro® or another hook and loop technology. Notice that the outer abdominal vest has a hood which functions to retain heat from the child's head. The hood can be fabricated from a thin insulated material or a bulky insulated material.

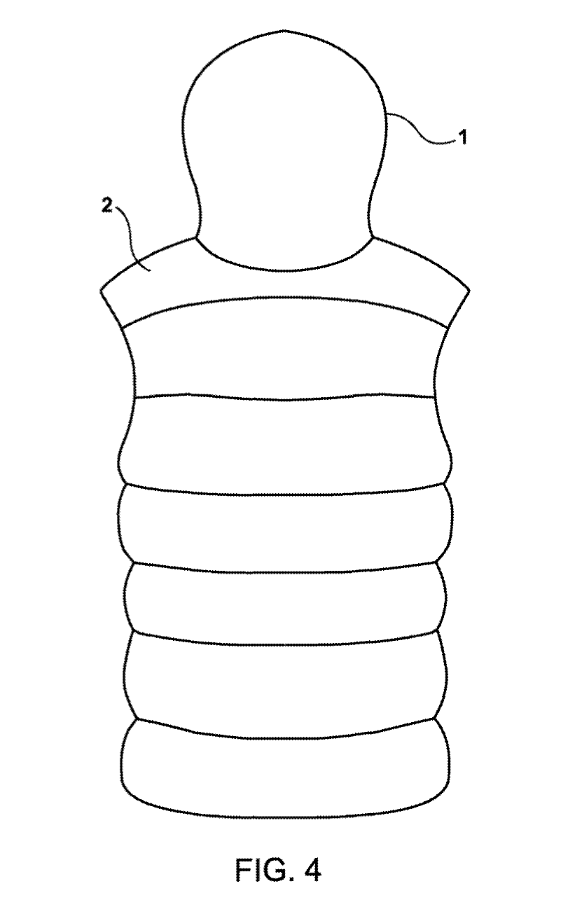

Now referring to FIG. 4 which shows a perspective view of the back of the outer abdominal vest layer. This part of the present invention jacket or coat apparel system is not intended to be worn while the child is in a five-point harness or similar safety device. It is anticipated by the Applicants that the hood can be present or not.

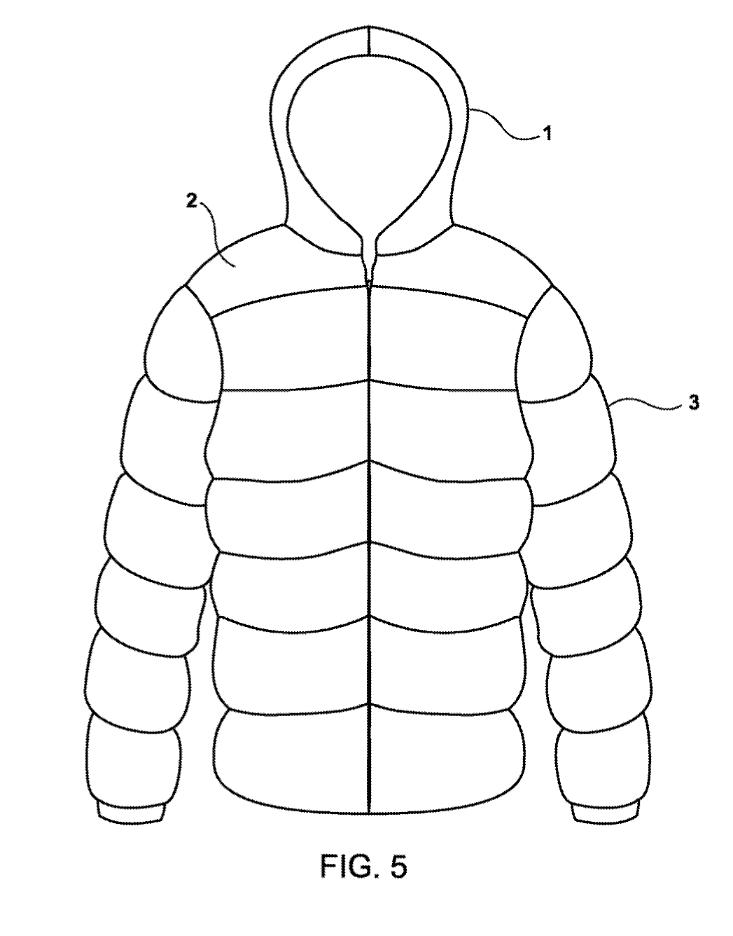

FIG. 5 is a perspective view of the front of the multi-layered jacked with a hood to be worn when the child is not secured by the restraining straps of a multipoint child's car seat.

Also shown in FIG. 5 is that the inner abdominal section 2 has a zipper adjoining the left and right panels. It is anticipated that the left and right panels can be joint by other means such as using a plurality of buttons with button holes, Velcro® or another hook and loop technology.

The combination of the inner base layer with outer abdominal vest yielding a multi-layered jacket or coat that is superior to single-layered jacket or coat. Thus, this present invention apparel system may be extremely versatile and convenient. It may provide the warmth of a winter coat but may be safe enough to be worn in a child safety seat, such as with a five-point harness. The apparel system may use layering to make it even warmer when worn all together. The apparel system also may protect the child from the elements in the event of a crash.

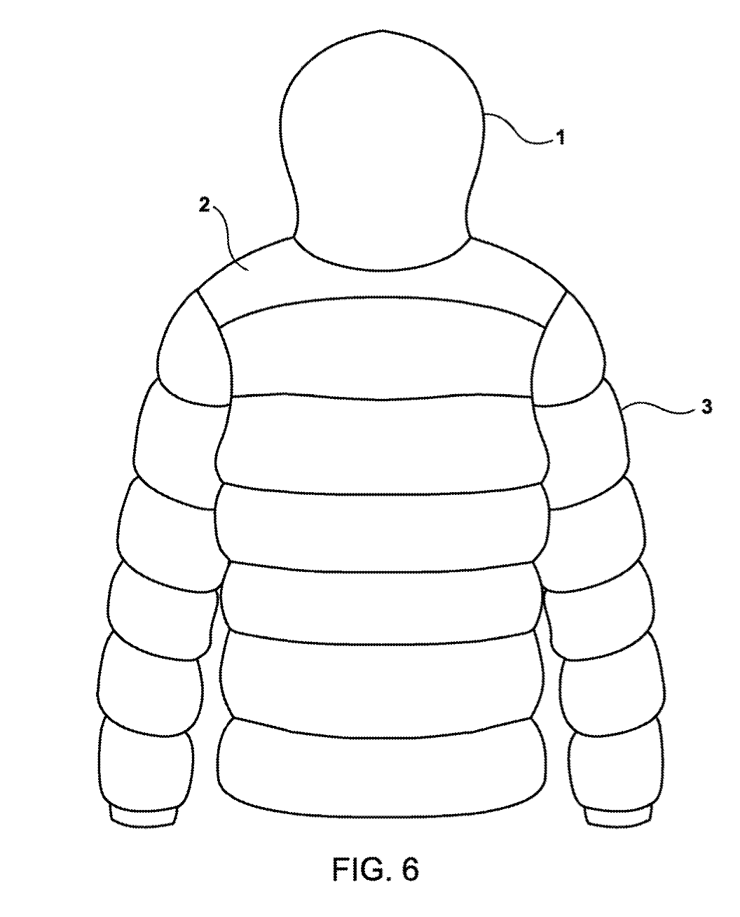

FIG. 6 is a perspective back view of the multi-layered jacked with a hood to be worn when the child is not secured by the restraining straps of a multipoint child's car seat.

As can be easily understood from the foregoing, the basic concepts of the present inventive technology may be embodied in a variety of ways. It involves both appareling techniques as well as devices to accomplish the appropriate apparel. In this application, the appareling techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this non-provisional application is intended to serve as a basic description. The reader should be aware that the specific discussion may not explicitly describe all embodiments possible; many alternatives are implicit. It also may not fully explain the generic nature of the inventive technology and may not explicitly show how each feature or element can actually be representative of a broader function or of a great variety of alternative or equivalent elements. Again, these are implicitly included in this disclosure. Where the inventive technology is described in device-oriented terminology, each element of the device implicitly performs a function. Apparatus claims may not only be included for the device described, but also method or process claims may be included to address the functions the inventive technology and each element performs. Neither the description nor the terminology is intended to limit the scope of the claims that will be included in any subsequent patent application.

It should also be understood that a variety of changes may be made without departing from the essence of the inventive technology. Such changes are also implicitly included in the description. They still fall within the scope of this inventive technology. A broad disclosure encompassing the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the inventive technology both independently and as an overall system.

Further, each of the various elements of the inventive technology and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the inventive technology, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this inventive technology is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of “apparel” should be understood to encompass disclosure of the act of “appareling”—whether explicitly discussed or not—and, conversely, were there effectively disclosure of the act of “appareling”, such a disclosure should be understood to encompass disclosure of “apparel” and even a “means for appareling.” Such changes and alternative terms are to be understood to be explicitly included in the description. Further, each such means (whether explicitly so described or not) should be understood as encompassing all elements that can perform the given function, and all descriptions of elements that perform a described function should be understood as a non-limiting example of means for performing that function.

Any patents, publications, or other references mentioned in this application for patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of References To Be Incorporated By Reference In Accordance With The Provisional Patent Application or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the apparel devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) an apparatus for performing the methods described herein comprising means for performing the steps, xii) the various combinations and permutations of each of the elements disclosed, xiii) each potentially dependent claim or concept as a dependency on each and every one of the independent claims or concepts presented, and xiv) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. The use of the phrase, “or any other claim” is used to provide support for any claim to be dependent on any other claim, such as another dependent claim, another independent claim, a previously listed claim, a subsequently listed claim, and the like. As one clarifying example, if a claim were dependent “on claim 20 or any other claim” or the like, it could be re-drafted as dependent on claim 1, claim 15, or even claim 25 (if such were to exist) if desired and still fall with the disclosure. It should be understood that this phrase also provides support for any combination of elements in the claims and even incorporates any desired proper antecedent basis for certain claim combinations such as with combinations of method, apparatus, process, and the like claims.

Finally, any claims set forth at any time are hereby incorporated by reference as part of this description of the inventive technology, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1. A multi-layered jacket or coat for a user to wear while secured in a car seat with a multi-point harness, and whereby said multi-layered jacked or coat also provides the warmth of a winter coat that is worn during outdoor winter activities, comprising;
an inner base layer having an abdominal section composed of a thin insulated material and is designed to partially engage the straps of a multi-point harness, said inner base layer open at the front with two front panels to facilitate dressing and includes a zipper, one or more buttons, hook and loop technology and/or other securing technology to secure the two front panels together;
said inner base layer having a front cut out or raised hem line;
said inner base layer having a pair of sleeves, said pair of sleeves attached to said base layer;
said inner base layer pair of sleeves are composed of a bulky insulated material;
said inner base layer to be worn when a user is secured in a car seat with a multi-point harness;
an outer abdominal vest, said outer abdominal vest opens at the front with two front panels to facilitate dressing and includes a zipper, one or more buttons, hook and loop technology, and/or other securing technology to secure the two front panels together;
said outer abdominal vest is composed of a bulky insulated material, said vest having a pair of sleeve holes;
said pair of bulky insulated sleeves of said inner base layer designed to be inserted through said pair of sleeve holes in said sleeveless outer abdominal vest whereby said outer abdominal vest overlays and interweaves said base layer forming a multi-layered jacket or coat; and
said multi-layered jacket or coat to be worn with when a user is not secured in a car seat with a multi-point harness.

2. The multi-layered jacket or coat of claim 1, further comprising a permanent or a removable hood attached to the vest such that when the user wears the base layer in the car seat with multi-point harness excessive bulk is minimized.

3. The multi-layered jacket or coat of claim 1, whereby the front cut out or raised hem line in the front section of said base layer minimizes interference with the buckle of the multi-point harness.

4. The multi-layered jacket or coat of claim 1, whereby the base layer with a pair of sleeves are composed of bulky insulated material to provide extra warmth, but do not interfere with the tightness of the multi-point harness.

5. The multi-layered jacket or coat of claim 1, whereby said bulky insulated material comprises Thinsulate®, Thermolite®, Primaloft®, Quallofil®, or any combinations thereof.

6. The multi-layered jacket or coat of claim 1, whereby the design of the multi-layered jacket or coat is more convenient and easier to make the correct and safe choice when using in car seats with a multi-point harness.

7. The multi-layered jacket or coat of claim 1, whereby said base layer is fabricated from a list comprising of fleece, fleece/nylon combination material, Polartec Power Shield®, and any combinations thereof.

8. The jacket or coat of claim 1, whereby the base layer abdominal or torso section composed of non-bulky, non-insulation sections that engage the straps of a harness and will fit as original designed by the car seat with multi-point harness manufacturer.

9. A multi-layered jacket or coat for a user to wear while secured in a car seat with a multi-point harness, and whereby said multi-layered jacked or coat also provides the warmth of a winter coat that is worn during outdoor winter activities, comprising;
a base layer having an abdominal or torso section that is composed of a non-bulky, non-insulated material and is designed to partially engage the straps of a multi-point harness, said base layer open at the front with two front panels to facilitate dressing and includes a zipper, one or more buttons, hook and loop technology and/or other securing technology to secure the two front panels together;
said inner base layer having a front cut out or raised hem line;
said inner base layer having a pair of sleeves, said pair of sleeves composed of a bulky, insulated material;
a sleeveless outer abdominal segment vest, said sleeveless outer abdominal segment vest open at the front with two front panels to facilitate dressing and includes a zipper, one or more buttons, hook and loop technology, and/or other securing technology to secure the two front panels together, said sleeveless outer abdominal segment vest having a hood;
said sleeveless outer abdominal segment vest is composed of a bulky, insulated material, said sleeveless outer abdominal segment vest having a pair of sleeve holes;
said pair of sleeves designed to be inserted through said pair of sleeve holes in said sleeveless outer abdominal section vest whereby said sleeveless outer abdominal segment vest overlays said inner abdominal section base layer forming a multi-layered jacket or coat; and
said multi-layered jacket or coat to be worn with when a user is not secured in a car seat with a multi-point harness.

10. The multi-layered jacket or coat of claim 9, whereby said front cut out or raised hem line design on the lower half of the front section on the inner abdominal section base layer prevents interference with the buckle of the harness.

11. The multi-layered jacket or coat of claim 9, whereby the inner abdominal section base layer has standard, non-bulky, insulation padding to provide extra warmth, but does not interfere with the tightness of the harness.

12. The multi-layered jacket or coat of claim 9, whereby said sleeveless outer winter jacket or coat outer abdominal segment vest includes a detachable or non-detachable hood.

13. The multi-layered jacket or coat of claim 9, whereby said bulky insulated material comprises Thinsulate®, Thermolite®, Primaloft®, Quallofil®, or any combinations thereof.

14. The multi-layered jacket or coat claim 9, whereby the design of the multi-layered jacket or coat is more convenient and easier to make the correct and safe choice when using seats with multi-point harnesses.

15. The multi-layered jacket or coat of claim 9, whereby the inner base layer is fabricated from a list comprising of fleece, fleece/nylon combination material, Polartec Power Shield®, and any combinations thereof.

16. The multi-layered jacket or coat of claim 9, whereby the inner base layer is composed of non-bulky, non-insulation sections that engage the straps of a harness and will fit as originally designed by the car seat with multi-point harness manufacturer.
